(19) United States
(12) Patent Application Publication
(10) Pub. No.: US 2007/0087687 A1
(43) Pub. Date: Apr. 19, 2007

(54) Method and device for transmitting broadcasting service

(75) Inventors: Jeong-hoon Park, Seoul (KR); Ga-hyun Ryu, Suwon-si (KR); Sun-hee Youm, Suwon-si (KR); Sung-il Park, Suwon-si (KR); Ju-hee Seo, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/524,281

(22) Filed: Sep. 21, 2006

(30) Foreign Application Priority Data
Oct. 19, 2005 (KR) 10-2005-0098728

(51) Int. Cl. H04H 7/00

(52) U.S. Cl. 455/3.06

(57) ABSTRACT

A method and a device are provided for transmitting a broadcasting service in which a broadcasting service from a broadcasting station received by a broadcasting receiver is transmitted to one or more external terminals. The method includes: detecting format conversion information indicating a format that the broadcasting service is to be converted into by communicating with the external terminals; converting the broadcasting service into a format corresponding to the detected format conversion information; and transmitting the converted broadcasting service to the external terminals. Accordingly, the received broadcasting service can be used in the external terminals employing different formats.

### CROSS-REFERENCE TO RELATED PATENT APPLICATION

This application claims priority from Korean Patent Application No. 1-2005-0098728, filed on Oct. 19, 2005, in the Korean Intellectual Property Office, the disclosure of which is incorporated herein in its entirety by reference.

### BACKGROUND OF THE INVENTION

1. Field of the Invention

Methods and devices consistent with the present invention relate to transmitting a broadcasting service, and more particularly, to transmitting a broadcasting service in which a broadcasting service received by a digital multimedia broadcasting receiver is converted to be compatible with an external terminal with a different format and is transmitted to the external terminal.

2. Description of the Related Art

In recent years, with rapid spread of digital audio instruments having excellent sound quality such as compact discs (CDs) and digital versatile discs (DVDs), requirements for digital broadcasting with excellent sound quality have increased more and more. In Europe, Canada, USA, and other countries, a digital audio broadcasting (DAB) service is provided to overcome the limitations of sound quality in the existing FM broadcasting.

A digital audio broadcasting system can provide high sound quality and excellent reception ability during movement by the use of technologies different from the existing AM broadcasting and FM broadcasting and can transmit digital data such as moving images and letters at a high speed.

Digital multimedia broadcasting (DMB) provides a variety of multimedia services including moving images rather than audio signals, DMB includes audio services having sound quality similar to CD, data services, and video services and provides excellent quality to both moving and stationary receivers.

A DMB receiver is used for receiving broadcasting at the time of movement of a vehicle and movement of a portable receiver. Specifically, the broadcasting receiving function is added to a mobile phone or a personal digital assistant (PDA), thereby providing convenience of watching the DMB anywhere.

In such DMB receivers, there is an attempt to utilize the received broadcasting service by communication with external terminals through wired or wireless networks.

However, when the DMB receiver is intended to transmit the broadcasting service to the external terminals through the wired or wireless networks, the external terminals have to use the same format as the DMB receiver. That is, even when the broadcasting service received by the DMB receiver is transmitted, the external terminals using formats different from that of the DMB receiver cannot use the transmitted broadcasting service.

### SUMMARY OF THE INVENTION

The present invention provides a method and a device for transmitting a broadcasting service in which a digital broadcasting service received by a digital multimedia broadcasting receiver is converted to be compatible with external terminal using different formats and is transmitted to the external terminals.

According to an aspect of the present invention, there is provided a method of transmitting a broadcasting service in which a broadcasting service from a broadcasting station received by a broadcasting receiver is transmitted to one or more external terminals, the method comprising: detecting format conversion information indicating into which format to convert the broadcasting service by communicating with the external terminals; converting the broadcasting service into a format corresponding to the detected format conversion information; and transmitting the converted broadcasting service to the external terminals.

According to another aspect of the present invention, there is provided a device for transmitting a broadcasting service received from a broadcasting station by a broadcasting receiver to one or more external terminals, the device comprising: an information detector detecting format conversion information indicating into which format to convert the broadcasting service by communicating with the external terminals; a format converter converting the broadcasting service into a format corresponding to the detected format conversion information; and a terminal communication unit transmitting the converted broadcasting service to the external terminals.

According to another aspect of the present invention, there is provided a computer-readable recording medium having embodied thereon a computer program for performing the method described above.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a device for transmitting a broadcasting service according to an exemplary embodiment of the present invention;

FIG. 2 is a block diagram specifically illustrating a broadcasting signal processor 110 shown in FIG. 1;

FIG. 3 is a block diagram specifically illustrating an information detector 140 shown in FIG. 1;

FIG. 4 is a diagram illustrating an example of a multiple structure of a digital broadcasting service used in FIG. 1;

FIG. 5 is a diagram illustrating a structure of a transmission frame used in FIG. 1;

FIG. 6 is a flowchart illustrating a method of transmitting a broadcasting service according to an exemplary embodiment of the invention; and

FIG. 7 is a flowchart specifically illustrating operation S620 in FIG. 6.

### DETAILED DESCRIPTION OF EXEMPLARY EMBODIMENTS OF THE INVENTION

Hereinafter, exemplary embodiments of the present invention will be described in detail with reference to the attached drawings.

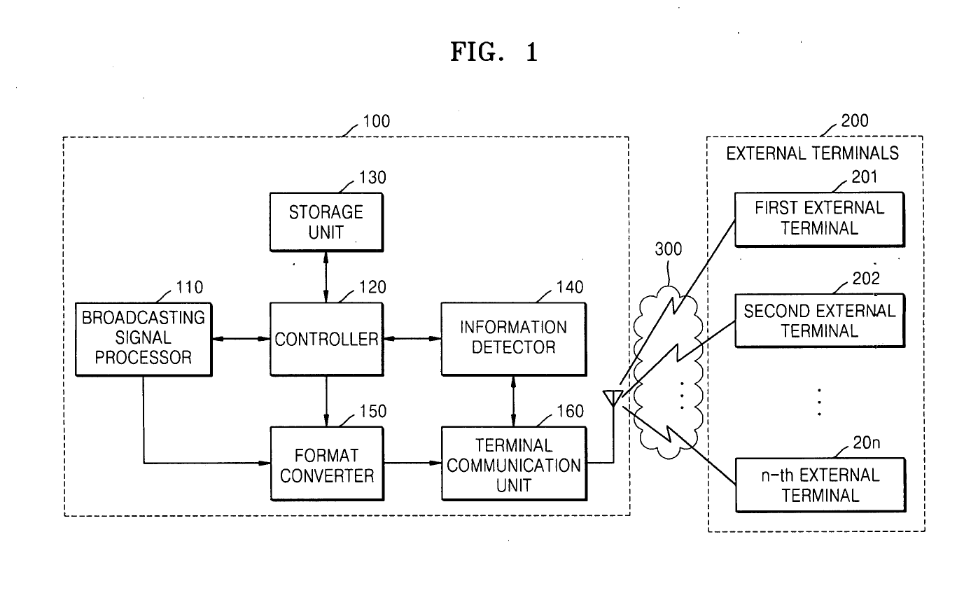

FIG. 1 is a block diagram illustrating a device for transmitting a broadcasting service according to an exemplary embodiment of the present invention. Referring to FIG. 1, a broadcasting service transmitting device 100 includes a broadcasting signal processor 110, a controller 120, a storage unit 130, an information detector 140, a format converter 150, and a terminal communication unit 160.

The broadcasting service transmitting device 100 is a broadcasting receiver, specifically, a DMB receiver. More specifically, a DMB service can be an example of the broadcasting service, but the invention is not limited thereto.

The terminal communication unit 160 of the broadcasting service transmitting device 100 communicates with a plurality of external terminals 200 through a network. The network may include wired and wireless networks. That is, the network may be a wired network or a wireless network. Referring to FIG. 1, the external terminals 200 include a first external terminal 201, a second external terminal 202, . . . , and an n-th external terminal 20n.

The operation shown in FIG. 1 can be performed to external terminals registered in the broadcasting service transmitting device 100 among the external terminals 200. That is, the conversion and transmission of a broadcasting service can be performed only to external terminals registered in the broadcasting service transmitting device 100, rather than to all the external terminals 200.

Examples of the external terminals 200 can include a variety of terminals such as MP3 players, electronic dictionaries, digital cameras, mobile phones, PDPs, and notebook computers.

The broadcasting signal processor 110 receives broadcasting signals from a broadcasting station, decodes broadcasting services included in the received broadcasting signals, and outputs the decoded broadcasting services to the format converter 150.

The broadcasting signal processor 110 of the broadcasting service transmitting device 100 displays the received broadcasting services on a display unit (not shown). That is, since the broadcasting service transmitting device 100 is a broadcasting receiver such as a DMB receiver as described above, the broadcasting service processed by the broadcasting signal processor 110 is displayed. In the exemplary embodiment, since the broadcasting services received from the broadcasting signal processor 110 are converted and transmitted to the external terminals 200, displaying the broadcasting service is not described.

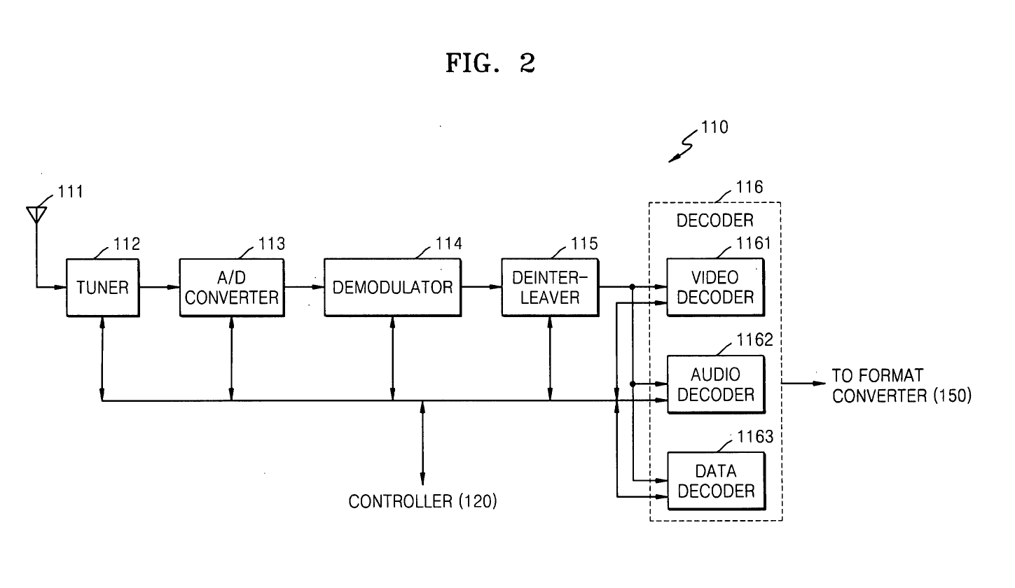

In general, a broadcasting service may include at least one of a video broadcasting service component, an audio broadcasting service component, and a data broadcasting service component. Details of the broadcasting signal processor 110 will be described below with reference to FIG. 2.

The storage unit 130 stores a variety of format information for converting the broadcasting service, which is received from a broadcasting station, into a format compatible with the external terminals 200 and providing the broadcasting service to the external terminals. As described above, when the external terminals 200 are MP3 players, electronic dictionaries, digital cameras, mobile phones, PDPs, and notebook computers, the storage unit 130 stores format information corresponding to the respective external terminals.

The information detector 140 determines external terminals which can receive the broadcasting service transmitted from the broadcasting station among the external terminals by communicating with the external terminals 200 through the terminal communication unit 160. The information detector 140 detects format conversion information indicating a format that the broadcasting service is to be converted into by communicating again with the external terminals 200 which are determined to want to receive the broadcasting service.

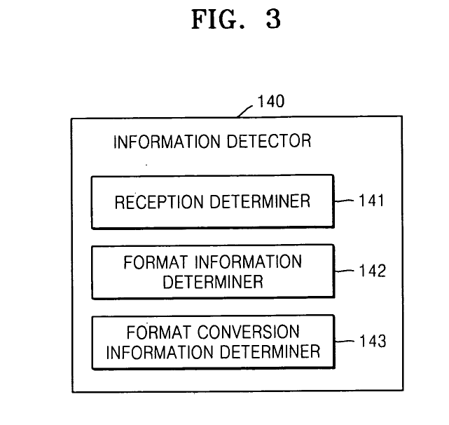

The information detector 140 is more specifically described with reference to FIG. 3. The information detector 140 includes a reception determiner 141, a format information determiner 142, and a format conversion information determiner 143.

The reception determiner 141 transmits a reception determination request message, which requests a determination of whether the broadcasting service transmitted from the broadcasting station would be received, to the external terminals 200 through the terminal communication unit 160. Then, the reception determiner 141 receives a reception determination response message from the external terminals 200 which would receive the broadcasting service among the external terminals 200.

The format information determiner 142 transmits a format information request message, which requests format information of the external terminals 200 to determine a format that the received broadcasting service is to be converted into, to the external terminals 200 having transmitted the reception determination response message through the terminal communication unit 160. The format information determiner 142 receives the format information from the external terminals 200.

The format conversion information determiner 143 determines whether format information corresponding to the format information of the external terminals 200 received by the format information determiner 142 is stored in the storage unit 130 and detects the corresponding format information as the format conversion information when the corresponding format information is stored in the storage unit 130. Then, the format conversion information determiner 143 outputs the detected formation conversion information to the format converter 150 through the controller 120.

On the other hand, when it is determined that the format information corresponding to the format information of the external terminals 200 received by the format information determined 142 is not stored in the storage unit 130, the formation conversion information determiner 143 transmits a format information re-request message to the external terminals 200 through the format information determiner 142. At this time, the format information determiner 142 may transmit the format information re-request message along with the format information of the broadcasting service transmitting device 100 stored in the storage unit 130.

The format converter 150 receives the format conversion information through the controller 120 and converts the broadcasting input from the broadcasting signal processor 110 into a format corresponding to the format conversion information.

The operation of the format converter 150 will be described in more detail. When the broadcasting service input from the broadcasting signal processor 110 is a broadcasting service including the video broadcasting service component, the audio broadcasting service component, and the data broadcasting service component and the format conversion information is format conversion information for MP3, the format converter 150 removes the video broadcasting service component from the broadcasting service and allows the broadcasting service to include the audio broadcasting service component and the data broadcasting service component. That is, the format converter 150 converts the broadcasting service into a broadcasting service having the format for MP3.

On the other hand, when it is determined that the format of the broadcasting service input from the broadcasting signal processor 110 through the controller 120 corresponds to the format of the external terminals 200, that is, when the format conversion need not be performed, the format converter 150 outputs the broadcasting service the terminal communication unit 160.

The terminal communication unit 160 receives the converted broadcasting service from the format converter 150 and transmits the converted broadcasting service to the external terminals 200.

The terminal communication unit 160 receives the reception determination request message, the format information request message, and the format information re-request message from the information detector 140 to transmit the messages to the external terminals 200 and receives the reception determination response message and the format information response message from the external terminals 200 to output the messages to the information detector 140.

The communication between the broadcasting service transmitting device 100 and the external terminals 200 is performed using the Session Initiation Protocol (SIP), the Session Description Protocol (SDP), or the H.323 protocol.

The H.323 protocol is an ITU-T standard for transmitting multimedia video conference data through a packet exchanging network such as TCP/IP. The H.323 protocol includes a local area network (LAN) standard for high-quality video and an Internet standard for transmitting low-frequency video through a slow network of 28.8 Kbps.

The SIP is a standard Voice over Internet Protocol (VoIP) issued from Internet Engineering Task Force (IETF) and serves to generate and end multimedia sessions between users over an IP network, similarly to the H.323 protocol. Specifically, the SIP is a very simple application hierarchy control protocol based on texture, in which one or more participants can generate, modify, and end sessions together. The sessions include a remote conference through the Internet, a telephone, an interview, an event notification, instant messaging, and the like. The SIP is independent of sub packet protocols (such as TCP, UDP, ATM, and X.25).

The SDP is a protocol for describing a multimedia session and is mainly used for describing a payload portion when a session is notified by periodically transmitting packets to predetermined multicast addresses and ports by the use of a session announcement protocol (SAP).

FIG. 2 is a block diagram specifically illustrating the broadcasting signal processor 110 shown in FIG. 1. Referring to FIG. 2, the broadcasting signal processor 110 includes an antenna 111, a tuner 112, an analog to digital (A/D) converter 113, a demodulator 114, a deinterleaver 115, and a decoder 116. The decoder 116 includes a video decoder 1161, an audio decoder 1162, and a data decoder 1163.

The tuner 112 tunes only radio frequency (RF) signals corresponding to the broadcasting service desired by a user among RF signals received through the antenna 111, converts the tuned RF signals into analog Intermediate Frequency (IF) signals, and outputs the converted signals to the A/D converter 113. The tuner 112 selects a frequency band of an ensemble modulation signal in which the broadcasting service desired by the user is multiplexed.

The A/D converter 113 digitalizes the analog IF signals tuned by the tuner 112 and outputs the digital signals to the demodulator 114.

The demodulator 114 performs Fast Fourier Transform (FFT) and differential demodulation on the digital signals output from the A/D converter 113 and then outputs the demodulated signals to the deinterleaver 115.

The deinterleaver 115 de-interleaves the demodulated signals in a frequency domain and then divides the signals into a fast information channel (FIC) signal as a control channel signal and a main service channel (MSC) signal as a data channel signal.

The MSC signal is de-interleaved again in a time domain. The video service component is output to and decoded by the video decoder 1161, the audio service component is output to and decoded by the audio decoder 1162, and the data service component is output to and decoded by the data decoder 1163. At the same time, the FIC signals are output to and decoded by the controller 120.

Although it has been exemplified in FIG. 2 that the broadcasting signal processor 110 includes the antenna 111, the tuner 112, the A/D converter 113, the demodulator 114, the deinterleaver 115, and the decoder 116, the invention is not limited to the example, but may be modified variously.

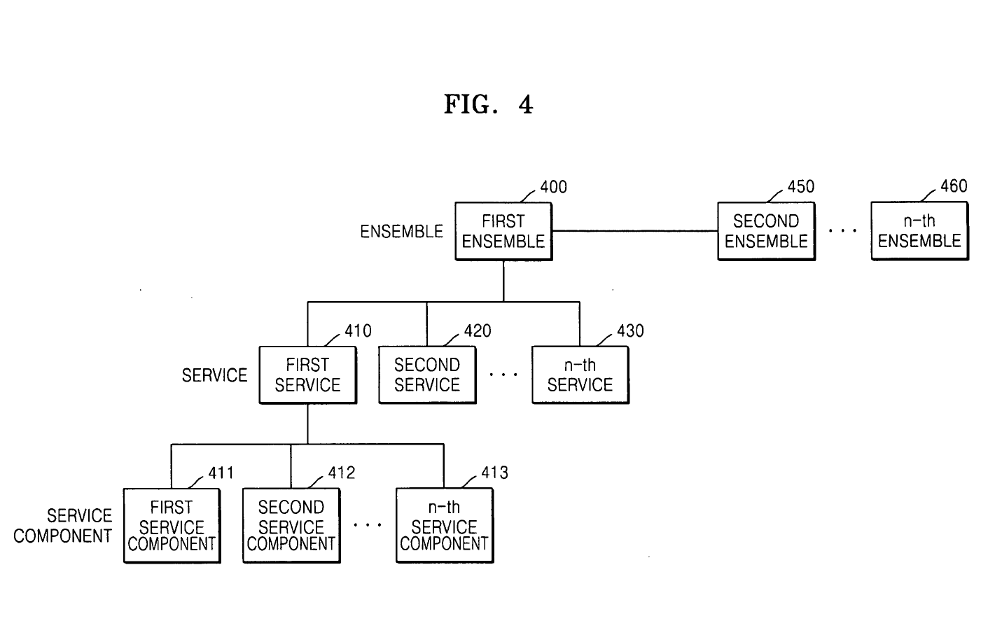

FIG. 4 illustrates a multiple structure of the digital broadcasting service used in FIG. 1.

The multiple structure of the digital broadcasting service includes ensembles, services, and service components. One or more broadcasting service components constitute a broadcasting service and one or more broadcasting services constitute an ensemble.

The ensemble is obtained by performing a channel coding process to the encoded video streams, the encoded audio streams, and the encoded data streams and multiplexing them along with system data into one bit stream. Generally, one broadcasting station provides one ensemble.

The service is an output selected by a user, such as the video service, the audio service, and the data service. The service components are elements constituting the service.

Multiplexer configuration information (MCI) is used as information indicating what services multiplexed in an ensemble and service components constituting the services are and where the service components are located.

Referring to FIG. 4, the first ensemble 400 includes a first broadcasting service 410, a second broadcasting service 420, . . . , and an n-th broadcasting service 430. Here, the first ensemble 400 includes n broadcasting services, but may include only one broadcasting service.

The first broadcasting service 410 includes a first broadcasting service component 411, a second broadcasting service component 412, . . . , and an n-th broadcasting service component 413. Here, the first broadcasting service 410 includes n broadcasting services, but may include only one broadcasting service component.

The second broadcasting service 420, . . . , and the n-th broadcasting service 430 may include components similar to those of the first broadcasting service 410.

The second ensemble 450, . . . , and the n-th ensemble 460 may include services similar to those of the first ensemble 400.

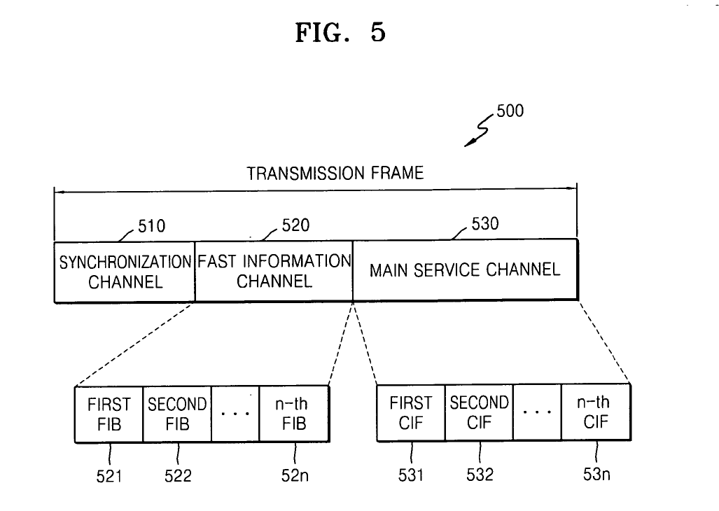

FIG. 5 shows an example of a structure of a transmission frame used in FIG. 1. Referring to FIG. 5, a digital broadcasting transmission frame 500 includes a synchronization channel (SC) 510, an FIC 520, and an MSC 530.

The synchronization channel 510 includes a null symbol, an Orthogonal Frequency Division Multiplexing (OFDM) symbol, and a reference symbol necessary for carrier frequency synchronization.

The fast information channel 520 is used to transmit a variety of information for receiving a broadcasting service and includes multiplexer configuration information (MCI), service information (SI), and fast information data channel (FIDC). The DMB receiver recognizes where service components of a service desired by a user are located in the main service channel, with reference to the multiplexer configuration information in the fast information channel. That is, the DMB receiver receives the desired broadcasting by extracting a portion including the service components of the service desired by the user from the broadcasting contents transmitted through the main service channel. Accordingly, the multiplexer configuration information is core information important for receiving the desired broadcasting service in the DMB in which a plurality of broadcasting services are multiplexed and transmitted.

Specifically, the fast information channel 520 in FIG. 5 includes a plurality of blocks of a first FIB 521, a second FIB, . . . , and an n-th FIB 52n.

The main service channel 530 includes one or more frames referred to as Common Interleaved Frames (CIFs) and serves to transmit video, sound, and data as contents provided from a broadcasting service provider.

Specifically, the main service channel 530 in FIG. 5 includes a plurality of frames of a first CIF 531, a second CIF 532, . . . , and an n-th CIF 53n.

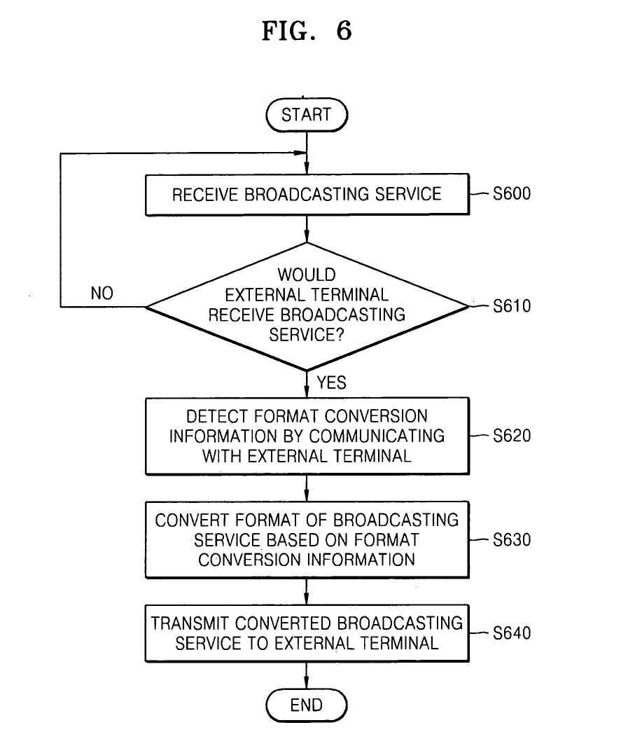

FIG. 6 is a flowchart illustrating a method of transmitting a broadcasting service according to an exemplary embodiment of the invention. Referring to FIG. 6, first, the broadcasting receiver receives broadcasting signals from a broadcasting station (S600). Here, the broadcasting receiver is the broadcasting service transmitting device in FIG. 1 (reference numeral 100 in FIG. 1), specifically, a DMB receiver, but is not limited thereto. A DMB service can be an example of the broadcasting service, but the invention is not limited thereto.

Next, it is determined whether the external terminals would receive the broadcasting service by communicating with external terminals (S610). At this time, the broadcasting receiver communicates with a plurality of external terminals through a network. The network includes wired networks and wireless networks. That is, the network may be a wired network or a wireless network. More specifically, a variety of terminals such as MP3 players, electronic dictionaries, digital cameras, mobile phones, PDPs, notebook computers may be used as the external terminals.

Operation S610 can be performed to only the external terminals registered in advance in the broadcasting receiver. That is, the broadcasting service can be transmitted to only the external terminals registered in advance in the broadcasting receiver, rather than to all the external terminals.

If it is determined in operation S610 that no external terminal would receive the broadcasting service, operation S600 is performed again. On the other hand, if it is determined in operation S610 that some external terminals would receive the broadcasting service, operation S620 is performed.

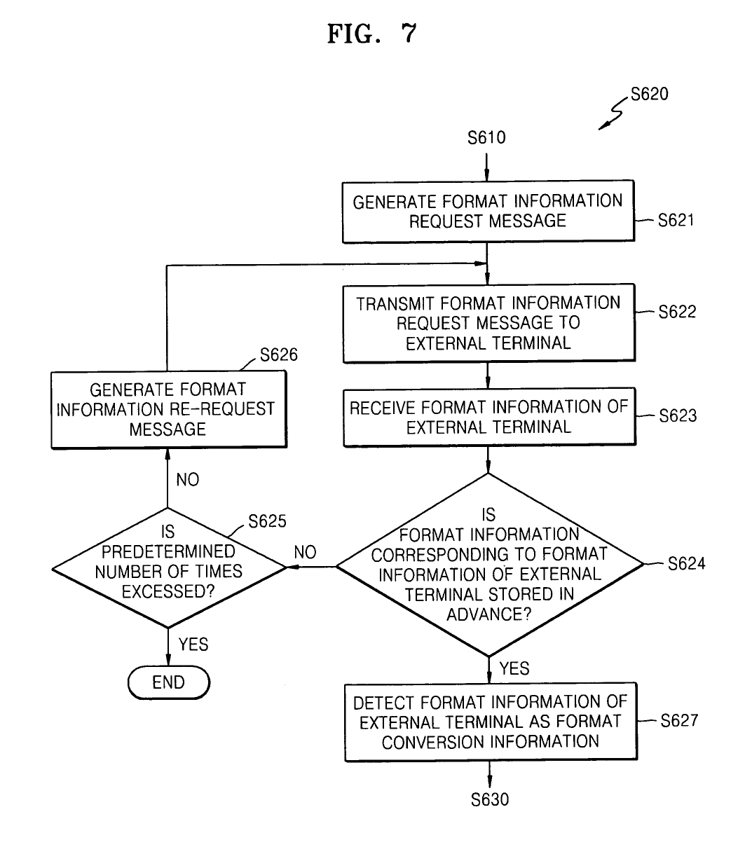

In operation S620, the format conversion information is detected by communicating with the external terminals. The detection of the format conversion information by communicating with the external terminals in operation S620 is described in more detail with reference to FIG. 7.

Next, in operation S630, the format of the broadcasting service is converted into a format corresponding to the format conversion information detected in operation S620. At this time, when it is determined that the format of the broadcasting signals transmitted from the broadcasting station corresponds to the format of the format conversion information detected in operation S620, that is, the format of the external terminals, the broadcasting receiver can perform operation S640 without performing the format conversion.

Next, the broadcasting service converted in operation S630 is transmitted to the external terminals (S640).

The operations of FIG. 6 not described are similar to those of FIGS. 1 to 5.

FIG. 7 is a flowchart illustrating in detail the detection of the format conversion information in operation S620 of FIG. 6.

First, a format information request message is generated to acquire format information of the external terminals (S621).

Next, the format information request message generated in operation S621 is transmitted to the external terminals (S622).

Next, a format information response message including the format information of the external terminals is received from the external terminals (S623).

Next, it is determined whether the format information corresponding to the format information of the external terminals included in the format information response message is stored in the storage unit of the broadcasting receiver (S624). If it is determined in operation S624 that the corresponding format information is not stored in the storage unit of the broadcasting receiver, operation S625 is performed. On the other hand, if it is determined in operation S624 that the corresponding format information is stored in the storage unit of the broadcasting receiver, operation S627 is performed.

In operation S625, it is determined whether the number of times is greater than or equal to a predetermined number of times. The determination is performed to end the flow of processes, when the broadcasting receiver transmits the format information request message to the external terminals the predetermined number of times but there is no corresponding format information. If it is determined in operation S625 that the number of times is greater than or equal to the predetermined number of times, the flow of procedure is ended. On the other hand, if it is determined in operation S625 that the number of times is not greater than or equal to the predetermined number of times, operation S626 is performed with increase in the number of times.

In operation S626, a format information re-request message is generated to determine again the format information of the external terminals. The format information re-request message generated in operation S626 may include a plurality of format information pieces stored in the storage unit of the broadcasting receiver. In this way, by transmitting the format information re-request message along with the plurality of format information pieces stored in the broadcasting receiver, the external terminals can transmit the corresponding format information.

In operation S627, the format information of the external terminals can be detected as the format conversion information.

The format information re-request message includes the plurality of format information pieces stored in the storage unit of the broadcasting receiver, but the format information request message may include the plurality of format information pieces stored in the storage unit of the broadcasting receiver.

In the method and device for transmitting a broadcasting service according to the invention described above, the broadcasting receiver such as a DMB receiver can utilize the DMB services by detecting format information corresponding to each other by communicating with the external terminals through a network, converting the broadcasting service into the format corresponding to the detected format information, and transmitting the converted broadcasting service to the external terminals.

Since the external terminals can utilize the broadcasting service, it is possible to increase the demand for DMB and the demand for DMB receivers.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method of transmitting a broadcasting service received from a broadcasting station by a broadcasting receiver, the method comprising:
detecting format conversion information by communicating with at least one external terminal;
converting the broadcasting service to a format corresponding to the detected format conversion information; and
transmitting the converted broadcasting service to the at least one external terminal.

2. The method of claim 1, wherein the detecting the format conversion information comprises:
transmitting to the at least one external terminal a format information request message requesting format information of the at least one external terminal;
receiving from the at least one external terminal a format information response message including the format information of the at least one external terminal;
determining whether format information corresponding to the format information of the at least one external terminal included in the format information response message is stored in the broadcasting receiver; and
detecting the format information of the at least one external terminal as the format conversion information if it is determined that the format information is stored in the broadcasting receiver.

3. The method of claim 2, further comprising transmitting to the at least one external terminal a format information re-request message requesting other format information stored in the at least one external terminal.

4. The method of claim 3, wherein the format information re-requesting message includes a plurality of format information pieces stored in the broadcasting receiver.

5. The method of claim 1, further comprising, before the detecting the format conversion information, determining whether the at least one external terminal would receive the broadcasting service by communicating with the at least one external terminal,
wherein only if it is determined that the at least one external terminal would receive the broadcasting service, the detecting the format conversion information is performed.

6. The method of claim 1, wherein the format conversion information is detected by performing communication using a session initiation protocol between the broadcasting receiver and the at least one external terminal.

7. The method of claim 1, wherein the format conversion information is detected by performing communication using a session description protocol between the broadcasting receiver and the at least one external terminal.

8. The method of claim 1, wherein the format conversion information is detected by performing communication using an H.323 protocol between the broadcasting receiver and the at least one external terminal.

9. The method of claim 1, wherein the broadcasting receiver is a digital multimedia broadcasting receiver.

10. The method of claim 1, wherein the at least one external terminal is registered in the broadcasting receiver.

11. A device for transmitting a broadcasting service received from a broadcasting station by a broadcasting receiver, the device comprising:
an information detector which detects format conversion information by communicating with at least one external terminal;
a format converter which converts the broadcasting service into a format corresponding to the detected format conversion information; and
a terminal communication unit which transmits the converted broadcasting service to the at least one external terminal.

12. The device of claim 11, wherein the information detector comprises:
a format information requester which requests the at least one external terminal to provide formation information of the at least one external terminal and receives from the external terminal the format information of the at least one external terminal; and
a format conversion information detector which determines whether the format information of the at least one external terminal is stored in the broadcasting receiver and detects the format information of the at least one external terminal as the format conversion information if it is determined that the format information is stored in the broadcasting receiver.

13. The device of claim 12, wherein the format conversion information detector comprises a reception determiner which determines whether the at least one external terminal would receive the broadcasting service by performing communication with the at least one external terminal, and
wherein the format information requester requests the at least one external terminal to provide the format information only if the reception determiner determines that the at least one external terminal would receive the broadcasting service.

14. The device of claim 11, further comprising a storage unit which stores a plurality of format information pieces corresponding to the format information of the at least one external terminal.

15. The device of claim 11, wherein the format conversion information is detected through communication using a session initiation protocol between the broadcasting receiver and the at least one external terminal.

16. The device of claim 11, wherein the format conversion information is detected through communication using a session description protocol (SDP) between the broadcasting receiver and the at least one external terminal.

17. The device of claim 11, wherein the format conversion information is detected through communication using an H.323 protocol between the broadcasting receiver and the at least one external terminal.

18. The device of claim 11, wherein the broadcasting receiver is a digital multimedia broadcasting receiver.

19. The device of claim 11, wherein the at least one external terminal is registered in the broadcasting receiver.

20. A computer-readable recording medium having embodied thereon a computer program for performing a method of transmitting a broadcasting service received from a broadcasting station by a broadcasting receiver, the method comprising:
detecting format conversion information by communicating with at least one external terminal;
converting the broadcasting service to a format corresponding to the detected format conversion information; and
transmitting the converted broadcasting service to the at least one external terminal.
